(19) United States
(12) Patent Application Publication
(10) Pub. No.: US 2006/0288737 A1
(43) Pub. Date: Dec. 28, 2006

(54) Method and apparatus for bending and tempering glass panels

(75) Inventor: Sami Sayahi, Kangasala (FI)

Correspondence Address: BUCHANAN, INGERSOLL & ROONEY PC, POST OFFICE BOX 1404, ALEXANDRIA, VA, 22313-1404, US

(73) Assignee: Tamglass Ltd. Oy, Tampere (FI)

(21) Appl. No.: 11/452,901

(22) Filed: Jun. 15, 2006

(30) Foreign Application Priority Data
Jun. 15, 2005 (FI) 20055309

(51) Int. Cl. C03B 31/00; C03B 27/00; C03B 23/02; C03B 21/00

(52) U.S. Cl. 65/106; 65/114; 65/289; 65/348

(57) ABSTRACT

A method and apparatus for bending and tempering glass panels includes a glass panel being heated to a tempering temperature and passed from a furnace's conveyor into a bending and tempering section for an arched roller mould, the glass bending upon its arrival thereon. The bent glass is subjected to a tempering blast. The first roller mould and a tempered glass article thereon are shifted out of the bending and tempering section in a direction substantially matching its own axis of curvature or the direction of rollers. The second, vacant roller mould is shifted into the bending and tempering section for receiving the next glass article to be bent, the bending-tempering of which is performed at the same time as the bent and tempered glass article is being removed from the first roller mould. The gained benefits include an increased capacity, a shortened cycle time and an economically attractive, durable construction.

### FIELD OF THE INVENTION

The invention relates to a method for bending and tempering glass panels, said method comprising heating a glass panel in a furnace to a tempering temperature and passing it into a bending and tempering section for an arched roller mould, which has an axis of curvature substantially codirectional with the rollers and upon its arrival thereon the glass panel bends, after which the bent glass is subjected to a tempering blast.

The invention relates also to an apparatus for bending and tempering glass panels, said apparatus comprising a heating furnace for glass panels, a conveyor and a bending and tempering section within the furnace, which is provided with an arched roller mould forming an extension to the furnace's conveyor and having an axis of curvature codirectional with the rollers, as well as nozzle blocks above and below the roller mould for blasting tempering air to the opposite sides of a bent glass panel.

### DESCRIPTION OF THE RELATED ART

This type of method and apparatus are known e.g. from patent publications U.S. Pat. Nos. 4,820,327 and 4,966,618. According to those, a bent and tempered glass panel is unloaded from the bending and tempering section in a direction consistent with the proceeding direction of a conveyor made up by the rolls of a roller mould. Especially with smaller radii of curvature, the only way of unloading a glass article from the bending and tempering section is almost perpendicularly upwards, which causes problems with heavy glass skidding in the conveying direction. This problem is not present in the Applicant's patent publication U.S. Pat. No. 4,497,645, in which the bending conveyor is made capable of being vaulted between flat and arched conditions. The bending conveyor is initially in a flat condition and then bends upon the arrival of a glass article. After tempering, the bending conveyor straightens out and the glass article is unloaded from the bending and tempering section. However, the arching mechanism for a bending conveyor is expensive, involving a power unit and a control system. In addition, times needed for conveyor vaulting operations increase cycle time and decrease capacity.

### SUMMARY OF THE-INVENTION

It is an object of the invention to improve a method and apparatus of the above-mentioned type in order to obviate such drawbacks. A particular object of the invention is to ensure high-quality optics with a high capacity and a short cycle time, while implementing the apparatus with an economically attractive and durable construction. This object is accomplished by a method the invention, whose characterizing features are set forth in the appended claim 1. The object is also accomplished by an apparatus of the invention, whose characterizing features are set forth in the appended claim 8. The dependent claims disclose preferred embodiments of the invention.

### BRIEF DESCRIPTION OF THE DRAWING FIGURES

The invention will now be described in more detail by way of working examples with reference to the accompanying drawings, in which:

FIG. 1 shows an apparatus implementing a method of the invention in a schematic side view in three different working phases.

FIG. 2 shows the same apparatus in a schematic plan view in next two working phases subsequent to phase 3 in FIG. 1.

FIG. 3 shows schematically an arrangement according to one embodiment of the invention for shifting a roller mould.

FIG. 4 shows an arrangement according to a second embodiment of the invention for shifting roller moulds.

FIG. 5 shows a further developed version of the embodiment of FIG. 4, comprising several roller moulds in an aftercooler.

### DETAILED DESCRIPTION OF THE INVENTION

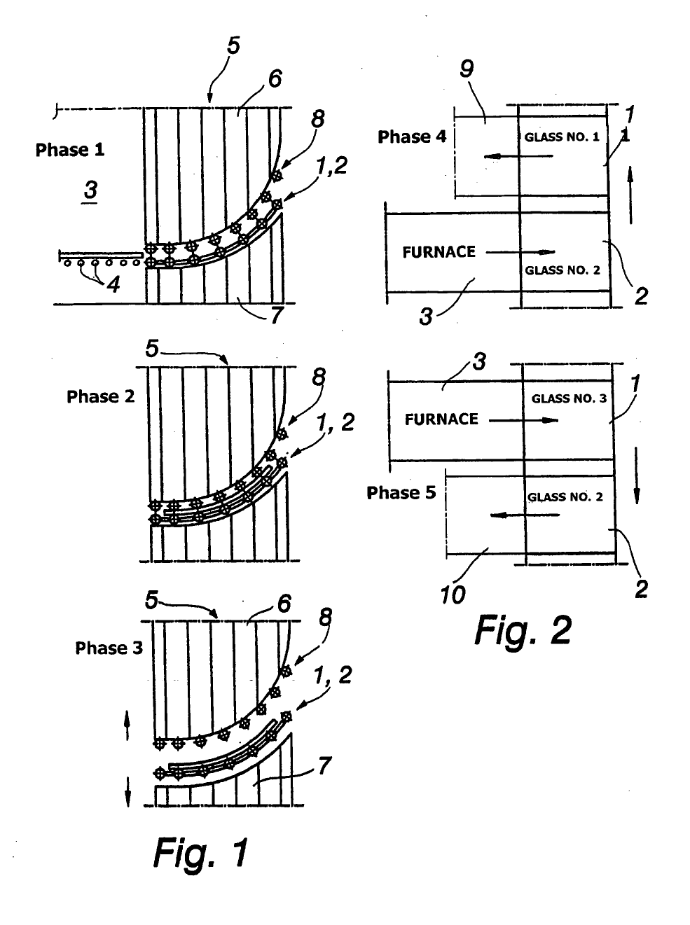

Reference is first made to an exemplary embodiment shown in FIGS. 1 and 2.

The apparatus for carrying out the method comprises a heating furnace 3 for glass panels, a conveyor 4 and a bending and tempering section 5 within the furnace, as well as unloading lines 9, 10 for bent and tempered glass articles on either side of the furnace 3.

The bending and tempering section 5 includes an arched roller mould 1, 2, which has an axis of curvature codirectional with the rollers. Above and below the roller mould 1, 2 are nozzle blocks 6, 7 for blasting tempering air to the opposite sides of a bent glass panel.

In Phase 1 of FIG. 1, the first roller mould 1 (or 2) lies between the nozzle blocks 6, 7 and the gap between the nozzle blocks has been narrowed to a temper-blast position. A glass article heated in the furnace 3 proceeds from the furnace's conveyor 4 onto the arched mould 1 and assumes a contour defined by the mould. Rolls or rollers 8, mounted below the top nozzle block 6, force the glass panel to conform to the curvature of the arched roller mould 1.

Phase 2 involves temper-blasting, which begins as soon as the glass article passes or reaches a predetermined point. In practice, by then the glass article has its trailing edge completely upon the arched conveyor of the roller mould 1.

Phase 3 begins once the temper-blasting is over. The nozzle blocks 6, 7 open up, i.e. are displaced in vertical direction for widening the gap therebetween. The required displacement is short, because all that is needed is an opening or a gap sufficient for moving the roller mould in the direction defined by its axis of curvature.

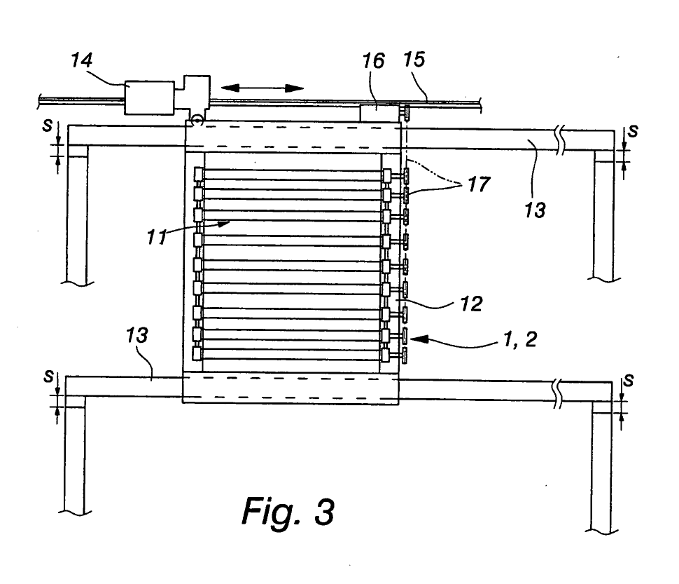

Phase 4, which is visible in FIG. 2, begins as soon as the nozzle blocks 6, 7 are open. At that point, the first and second roller moulds 1, 2 switch positions. The roller mould 1, with a bent glass article thereon, takes a position alongside the bending and tempering section 5 which enables the unloading of glass No. 1 onto an unloading line 9. The second, vacant roller-track mould 2 is placed into the bending and tempering section 5 for receiving the next bent glass article (glass No. 2) from the furnace 3. The shifting of roller moulds can be enabled, for example, by means of powerful servos 14 (FIG. 3), thus saving time. The bending and tempering of a glass panel proceeding onto the vacant roller mould 2 can be performed simultaneously with the removal of a bent and tempered glass panel from the roller mould 1 onto the unloading line 9.

In Phase 5, the roller mould 2, carrying a bent and tempered glass article thereon, is proceeded in the direction consistent with its axis of curvature out of the bending and tempering section to the end of an unloading line 10, while at the same time the first, vacated roller mould 1 is returned to provide an extension to the furnace's conveyor ready to take up the next glass article (glass No. 3).

As evident from the foregoing Phases 1-5, two arched roller moulds 1, 2 are operated back and forth in a direction substantially consistent with that of the rollers, such that each roller mould takes its turn in the bending and tempering section 5 while the other roller mould is located to the right or left of the bending and tempering section 5 for the removal of a bent and tempered glass panel from the roller mould while performing the bending-tempering process of a glass panel presently on the other roller mould. The nozzle blocks 6, 7 included in the bending and tempering section 5 are shifted in vertical direction to provide a wider gap therebetween for the time of ejecting the first roller mould 1 and replacing it with the second roller mould 2. This is followed by shifting the nozzle blocks 6, 7 in vertical direction for narrowing the gap therebetween to a temper-blast position before the next glass panel is completely on the other roller mould 1, 2.

In a preferred embodiment of the invention (FIG. 3), the roller mould 1, 2 consists of a roller conveyor 11, having a variable degree of curvature, and a mould 12 which receives the roller conveyor and dictates its degree of curvature. The roller conveyors 11 and also the moulds 12 can be mounted on two runners 13, having their heights adjustable (adjustment s) to match a proper design. The nozzle blocks 6, 7 also have their configurations adjusted to match a respective design. The arched roller conveyor 1, 2 can also be given a fixed design, but this adds to the overall costs of the apparatus. A motor 16 driving the roller conveyor's 11 rolls and the servo motor 14 shifting the roller mould receive their power supply, in a per se known manner, from a power transmission chain 15.

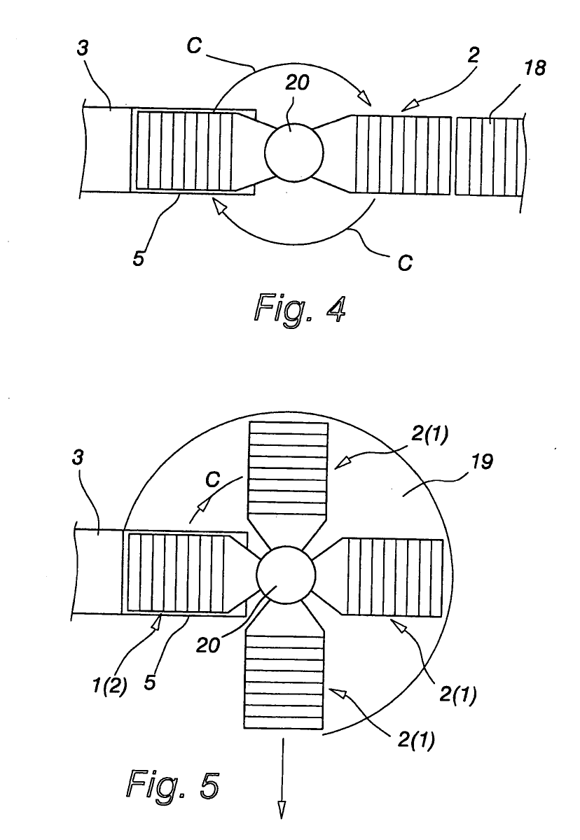

In the exemplary embodiment of FIG. 4, the displacement of roller moulds 1, 2 in a direction substantially consistent with that of the axis of curvature thereof is provided in such a way that the roller moulds 1, 2 are proceeded along such a circular arc C that has a tangent codirectional with the rollers. In the depicted case, the two roller moulds 1, 2 lie on the opposite sides of a turntable 20. An unloading line 18, which also includes aftercooling equipment, is provided in the present case on a conveyance-directed extension of the roller mould 2. The roller mould 2 present outside the bending and tempering section 5 can be readily accompanied with necessary transfer means for passing tempered and bent glass panels from the roller mould 2 onto the unloading line 18. The roller mould 2 and the unloading line 18 may extend in any direction with respect to the direction of the furnace 3.

The embodiment of FIG. 5 comprises four roller moulds 1, 2 mounted 90° intervals on the turntable 20. Each roller mould takes its turn in the bending and tempering section 5 while the remaining roller moulds stay outside the bending and tempering section 5 in a circular aftercooling section 19. The final roller mould, as viewed in the roller moulds' rotating direction, has already come out of the aftercooling section 19 and the cooled glass panels can be passed over onto the unloading line or loaded directly on storage and shipping stands. In the embodiments of FIGS. 4 and 5, at least two roller moulds 1, 2 are also shifted simultaneously in such a way that, as one roller mould leaves the bending and tempering section 5, another one will take its place. Switching places proceeds along a circular-arc shaped track C. The unloading line 18 and the aftercooling section 19 can be provided with conventional cooling blast.

The invention is not limited to the foregoing exemplary embodiments which are described for the sole purpose of illustrating various options of implementing the invention.

What is claimed is:

1. A method for bending and tempering glass panels, said method comprising heating a glass panel in a furnace to a tempering temperature and passing it into a bending and tempering section for an arched roller mould which has an axis of curvature substantially codirectional with the rollers and upon its arrival thereon the glass panel bends, after which the bent glass is subjected to a tempering blast, wherein the first roller mould, along with a bent tempered glass panel thereon, is shifted substantially codirectionally with its axis of curvature and the rollers out of the bending and tempering section and the second, vacant roller mould is shifted into the bending and tempering section for receiving the next glass article to be bent.

2. A method as set forth in claim 1, wherein at least two arched roller moulds are shifted substantially codirectionally with the axis of curvature thereof, such that each one takes its turn in the bending and tempering section while the other roller mould lies outside the bending and tempering section for removing a bent and tempered glass panel from the roller mould while simultaneously performing the bending-tempering of a glass panel presently on the other roller mould.

3. A method as set forth in claim 1, wherein nozzle blocks included in the bending and tempering section are displaced in vertical direction for widening the gap therebetween for the time needed for shifting the first roller mould out and replacing it with the second roller mould, whereafter the nozzle blocks are displaced in vertical direction for narrowing the gap therebetween to a tempering blast position before the next glass panel is completely on the second roller mould.

4. A method as set forth in claim 1, wherein bent and tempered glass panels are unloaded in an alternating manner onto unloading lines on either side of the furnace, the first unloading line of which is used for unloading the bent and tempered glass panels from the first roller mould and the second unloading line is used for unloading the bent and tempered glass panels from the second roller mould.

5. A method as set forth in claim 1, wherein the roller moulds are shifted in a direction substantially matching that of their axis of curvature by moving the roller moulds along such a circular arc that has a tangent codirectional with the rollers.

6. A method as set forth in claim 1, wherein at least two roller moulds are shifted simultaneously in such a way that, as one roller mould is leaving the bending and tempering section, the other will take its place.

7. A method as set forth in claim 1, wherein one or several roller moulds presently outside the bending and tempering section are conveyed through an aftercooling section.

8. An apparatus for bending and tempering glass panels, said apparatus comprising a heating furnace for glass panels, a conveyor and a bending and tempering section within the furnace, which is provided with an arched roller mould forming an extension to the furnace's conveyor and having an axis of curvature codirectional with the rollers, as well as nozzle blocks above and below the roller mould for blasting tempering air to the opposite sides of a bent glass panel, wherein at least two arched roller moulds are adapted to be shifted in a direction substantially matching their axis of curvature, such that each roller mould takes its turn in the bending and tempering section as an extension to the furnace's conveyor while the other roller mould lies outside the bending and tempering section for the removal of a bent and tempered glass panel from the roller mould.

9. An apparatus as set forth in claim 8, wherein the roller mould includes a roller conveyor, having a variable degree of curvature, and a mould which receives the roller conveyor and dictates its degree of curvature.

10. An apparatus as set forth in claim 8, wherein the furnace has on either side thereof an unloading line and each unloading line receives bent and tempered glass panels in an alternating fashion.

11. An apparatus as set forth in claim 8, wherein at least two arched roller moulds are adapted to be displaced along such a circular arc, whose tangent is substantially codirectional with the rollers.

12. An apparatus as set forth in claim 8, wherein the roller moulds have a proceeding path which extends through an aftercooler.
